(19) United States
(12) Patent Application Publication
(10) Pub. No.: US 2012/0024865 A1
(43) Pub. Date: Feb. 2, 2012

(54) SPRINGFORM PAN

(76) Inventor: Horst RIEDL, Schrobenhausen (DE)

(21) Appl. No.: 13/163,047

(22) Filed: Jun. 17, 2011

(30) Foreign Application Priority Data
Jul. 28, 2010 (DE) 10 2008 038 526.3
Apr. 20, 2011 (DE) 10 2011 007 809.6

(51) Int. Cl. A21B 5/00; A47J 37/01

(52) U.S. Cl. 220/573.1; 99/426

(57) ABSTRACT

A springform pan for baking pastries, in particular cake, comprises a bottom, a rim which is connectable to the bottom and comprises a first rim portion, a second rim portion and a third rim portion as well as a closure which is provided at the third rim portion for opening and closing the springform pan, with the first rim portion and the second rim portion being pivotably connected to each other.

### CROSS-REFERENCE TO RELATED APPLICATIONS

This application claims the priority of German Patent Applications, Serial Nos. DE 10 2010 038 526.3 filed on Jul. 28, 2010, and DE 10 2010 007 809.6 filed on Apr. 20, 2011, pursuant to 35 U.S.C. 119(a)-(d), the content of which is incorporated herein by reference in its entirety as if fully set forth herein.

### FIELD OF THE INVENTION

The invention relates to a springform pan for baking pastries, in particular cake.

### BACKGROUND OF THE INVENTION

### Background Art

Springform pans for baking pastries and in particular for baking cake are known for a longer period of time through prior public use. Springform pans of this type have substantially simple, regular geometries and are for example round or rectangular. The reason for this is that the springform pan comprises a closure which is known per se and which causes the rim of the springform to expand when opened.

### SUMMARY OF THE INVENTION

It is an aspect of the invention to improve a springform pan in such a way that there is a variety of shapes for the springform pan to be selected from.

This aspect is achieved by a springform pan for baking pastries, in particular cake, with the springform pan comprising a bottom, a rim which is connectable to the bottom, the rim comprising a first rim portion, a second rim portion and a third rim portion, and a closure which is provided at the third rim portion for opening and closing the springform pan, with the first rim portion and the second rim portion being pivotably connected to each other. The gist of the invention is that two adjacent rim portions of a rim which comprises a plurality of rim portions are pivotably connected to each other. This may be done in particular by means of a hinge; alternatively, the rim may also be designed in one piece. To this end, the rim may for example have a reduced height and/or sheet metal thickness in the region of the pivotable articulation of the two rim portions. The design of the springform pan according to the invention provides for an increased flexibility of the rim, thus enabling even springform pans with complex contours to be opened and closed. This allows a springform pan to be formed which has a new contour that had been impossible so far such as in particular a contour in the shape of a segment of a circle having a center, with the central angle advantageously amounting to 90°. Such a contour corresponds to a quarter of a circle so that when a springform pan of this type is used several times, this allows one to produce a circular cake consisting of four individual quarters of a cake, it being possible for each of the four quarters to look different. By means of the springform pan according to the invention, it is conceivable as well to form other contours such as for example contours in the shape of a segment of a circle having a central angle different from 90° or even contours in the shape of a triangle. The springform pan according to the invention increases the variety of shapes for the springform pan.

Additional features and details of the invention will become apparent from the ensuing description of two embodiments by means of the drawing.

### BRIEF DESCRIPTION OF THE DRAWING

FIG. 1 is a perspective view of a springform pan according to the invention;

FIG. 2 is a partially sectional side view of the springform pan according to FIG. 1;

FIG. 3 is a perspective view of a springform pan according to the invention according to a second embodiment; and

FIG. 4 is a sectional view of a rim region of the springform pan shown in FIG. 3.

### DESCRIPTION OF THE PREFERRED EMBODIMENTS

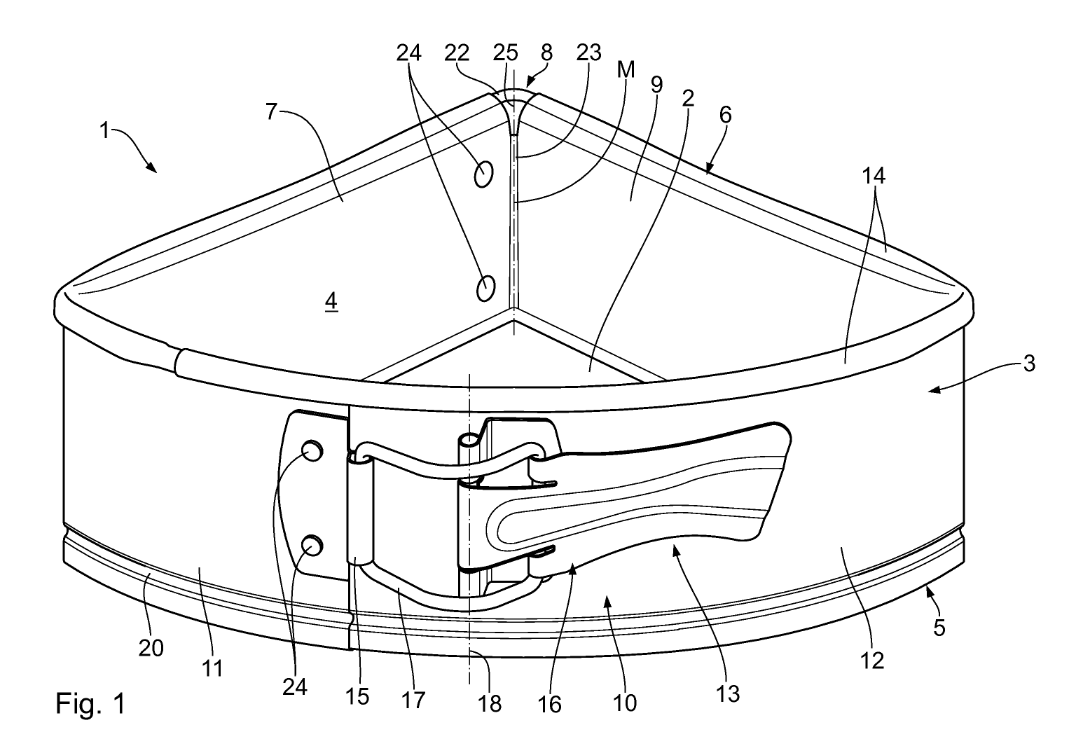

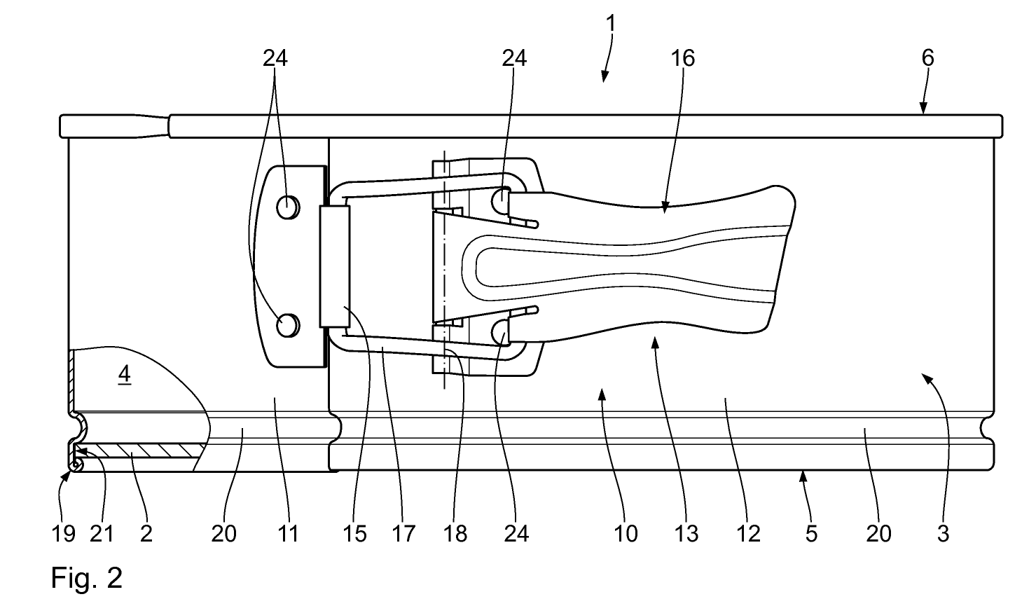

A springform pan 1 according to a first embodiment shown in FIGS. 1 and 2 comprises a bottom 2 and a rim 3 which is connectable to the bottom 2.

The springform pan 1 encloses an inner space 4 which may be filled with a raw mixture such as dough for baking in particular a cake. The bottom 2 is arranged at a lower side 5 of the rim 3. Correspondingly, the springform pan 1 is open on an upper side 6 of the rim 3, which is opposite to the lower side 5, in order to be filled with dough, for example.

The bottom 2 is made of a steel plate and is coated on both sides, in other words on an upper side facing the inner space 4 and on a lower side remote from the inner space 4, with a non-stick coating such as Teflon or enamel, in particular flexible enamel.

The rim 3 has a multi-part design and comprises a first rim portion 7 and a second rim portion 9 which is pivotably connected to the first rim portion 7 by means of a hinge 8. Furthermore, a two-part third rim portion 10 is provided which comprises an outer part 11 and an inner part 12. The third rim portion 10 is provided with a closure 13 which is known per se for springform pans for opening and closing the springform pan 1. By operating the closure 13, the outer part 11 and the inner part 12 are displaced relative to each other along a contour of the rim 3. The outer part 11 is connected with the first rim portion 7 in such a way as to form one piece. The inner part 12 is connected with the second rim portion 9 in such a way as to form one piece.

It is conceivable as well for the rim 3 to be designed in one piece in such a way that the first rim portion 7 and the second rim portion 9 are formed as an integral unit. A pivoting movement between the first rim portion 7 and the second rim portion 9 is achievable for example by reducing the sheet metal thickness of the rim 3 and/or the height of the rim 3 in the relevant region.

The rim 3 has a contour in the shape of a segment of a circle having a center M, with the central angle amounting to 90° in the embodiment shown. It is conceivable as well to select other central angles for a springform pan. Corresponding to the contour of the quarter of a circle, the first rim portion 7 and the second rim portion 9 have a plane surface. The third rim portion 10 on the other hand has a convex shape.

The upper side 6 of the rim 3 is provided with a circumferential bulge 14, with the bulge 14 having a substantially ring-shaped cross-section in a sectional plane which is perpendicular to the contour of the springform pan 1. In a connection region between the outer part 11 and the inner part 12, the size of the bulge 14 of the outer part 11 is reduced in such a way that the bulge 14 is insertable into the bulge of the inner part 12.

The rim 3 is made of a strip of sheet metal for example of steel or stainless steel although other materials are suitable for producing the rim 3 for the springform pan 1 as well. On the lower side 5, the rim 3 is rolled up such as to form a flared edge 19. A contour formed by the flared edge 19 serves as a support for the springform pan 1 on a basis. Adjacent to the flared edge 19, the rim 3 is provided with a circumferential bead 20 in such a way that the bead 20 projects into the inner space 4 of the springform pan 1. The flared edge 19 is designed in such a way as to be directed in the direction of the inner space 4 of the springform pan 1. Between the flared edge 19 and the bead 20, a groove 21 is formed into which the bottom 2 is insertable.

A width of the groove 21 corresponds to a thickness of the bottom 2, allowing the bottom 2 to be securely fastened to the rim 3 so as to form the springform pan 1 when the closure 13 is closed. FIGS. 1 and 2 show the closure 13 in a closed position.

In the connection region of the inner part 12, the flared edge 19 is reduced in such a way that the inner part 12 is insertable into the flared edge 19 of the outer part 11. As the bulge 14 of the outer part 11 is guided in the bulge 14 of the inner part 12 while the flared edge 19 of the inner part 12 is guided in the flared edge 19 of the outer part 11, the parts 11, 12 are arranged relative to each other in such a way as to ensure a secure and controlled displacement along the contour of the rim 3.

The closure 13 comprises a fastening sleeve 15 which is attached to the outer part 11 and an operating lever 16 which is secured to the inner part 12 and is pivotably connected to the fastening sleeve 15 by means of a bracket 17. Furthermore, the operating lever 16 is attached to the inner part 12 in such a way as to be pivotable about a pivot axis 18 which is perpendicular to the bottom 2. By pivoting the operating lever 16 about the pivot axis 18, the fastening sleeve 15 is displaced along the contour of the rim 3 through the bracket 17 which is opposite to the operating lever 16. The closure 13 is secured to the outer part 11 and to the inner part 12 by means of several rivets 24.

The hinge 8 comprises a bending wire 22 which is inserted into the bulges 14 of the first rim portion 7 and of the second rim portion 9 in such a way that the first and the second rim portion 7, 9 are connected to each other by the bending wire 22. The bending wire 22 completes the contour of the bulge 14 of the rim 3 which is interrupted in the region of the first and second rim portion 7, 9 to form the contour which is in the shape of a quarter of a circle, the bending wire 22 being formed in such a way as to correspond to the central angle of 90°. Furthermore, the hinge 8 comprises a connection strip 23 which is made of stainless steel. The connection strip 23 has a high rigidity and good elastic properties at the same time. The connection strip 23 is formed in one piece with the second rim portion 9 and is securely connected to the first rim portion 7 by means of two rivets 24. The connection strip 23 may also be a separate component. The sheet metal thickness of the connection strip 23 may then be reduced for example relative to the sheet metal thickness of the rim 3.

In addition to the bending wire 22, the hinge 8 is provided with another bending wire which is not shown, the second bending wire being guided in the flared edges 19 of the first and second rim portions 7, 9 so as to connect the two rim portions 7, 9 with each other. By combining the two bending wires 22 with the connection strip 23, a hinge 8 is produced which ensures a connection of the two rim portions 7, 9 that is rigid and flexible at the same time. The flexibility of the hinge 8 in particular provides for an easier opening of the springform pan 1 by means of the closure.

The hinge 8 is arranged in the center M of the contour which is in the shape of a segment of a circle. The hinge 8 may also be provided in a different shape, with the pivoting movement of the two rim portions 7, 9 relative to each other being ensured by a hinge axis 25 which is in particular perpendicular to the bottom 2.

The following is an explanation of the functioning of the springform pan 1 according to the invention. Starting from the arrangement of the springform pan 1 according to FIGS. 1 and 2 in which the closure 13 is in the closed position, the operating lever 16 is operated by pulling the operating lever 16 away from its position abutting the rim 3. When this happens, the operating lever 16 is pivoted about the pivot axis 18 in a manner known per se which causes the bracket 17, which is connected to the operating lever 16, to be displaced from the inner part 12 of the third rim portion 10 towards the outer part 11. The bracket 17 is arranged in the fastening sleeve 15, which is securely fastened to the outer part 11, so as to be pivotable in such a way that when the bracket 17 is displaced by opening the closure 13, the outer part 11 and the inner part 12 are moved away from each other along the contour of the rim 3. The opening movement of the parts 11, 12 relative to each other is guided along the flared edge 19, the bulge 14 and the rim 3, with the outer part 11 being in a surface-to-surface contact with the inner part 12 between the bulge 14 and the flared edge 19. As the parts 11, 12 are in each case connected with the rim portions 7, 9 in such a way as to form one piece, the bending wires 22 and connection strips 23 of the hinge 8 are elastically bent up which causes the central angle of the rim 3—amounting to 90° in the closed position—to be slightly increased which in turn causes the contour of the rim 3 to expand. Consequently, the groove 21 in which the bottom 2 is held in place when the springform pan 1 is closed is expanded as well so that the bottom 2 is removable from the groove 21 when the springform pan 1 is in an open position. The central angle of the bottom 2 amounts to 90° and remains unchanged when the closure 13 is operated. When the central angle of the rim 3, which central angle is arranged at the hinge 8, is increased by for example a few degrees when the closure 13 is opened, this causes the contour of the rim 3, which is in the shape of a segment of a circle, to be increased with respect to the segment of a circle of the bottom 2 when in the open position. The closure 13 allows the contour of the rim 3 to expand to such an extent that the bottom is removable from the groove 21, and thus from the springform pan 1, either via the bead 21 or via the flared edge 19. Correspondingly, when the springform pan 1 is in its open position, the bottom 2 is insertable into the groove 21 so as to be safely clamped in the groove 21 when the closure 21 is closed again.

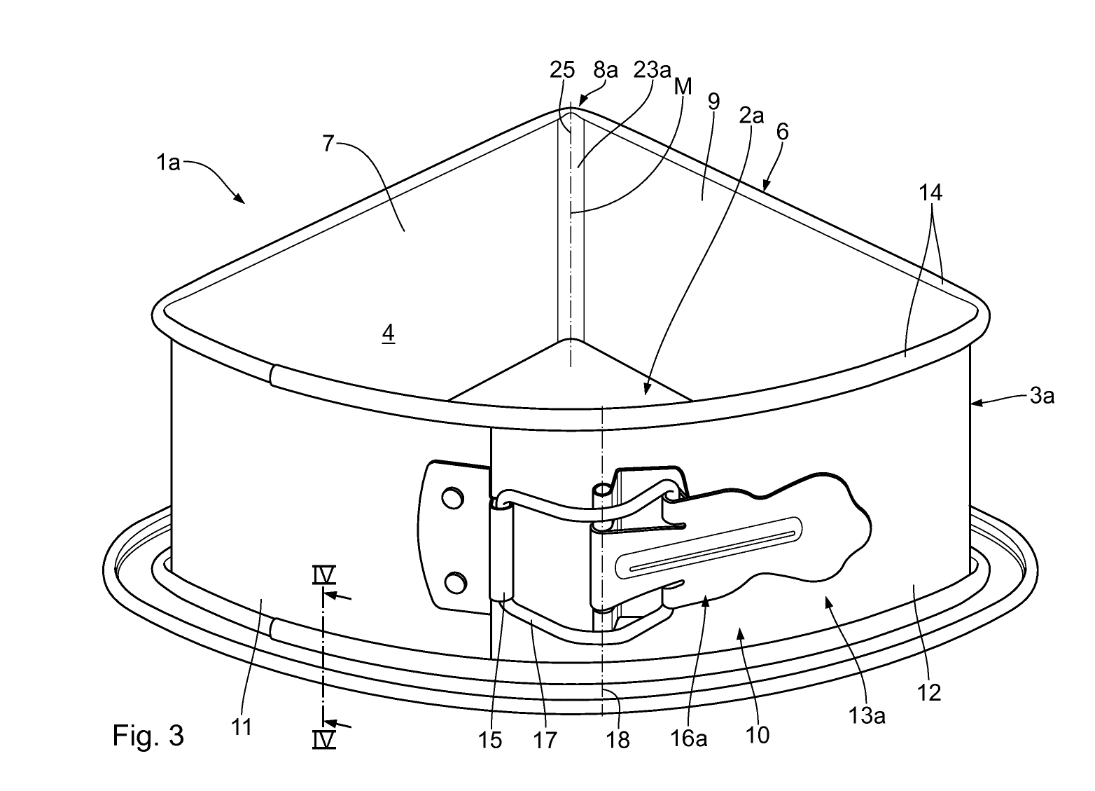

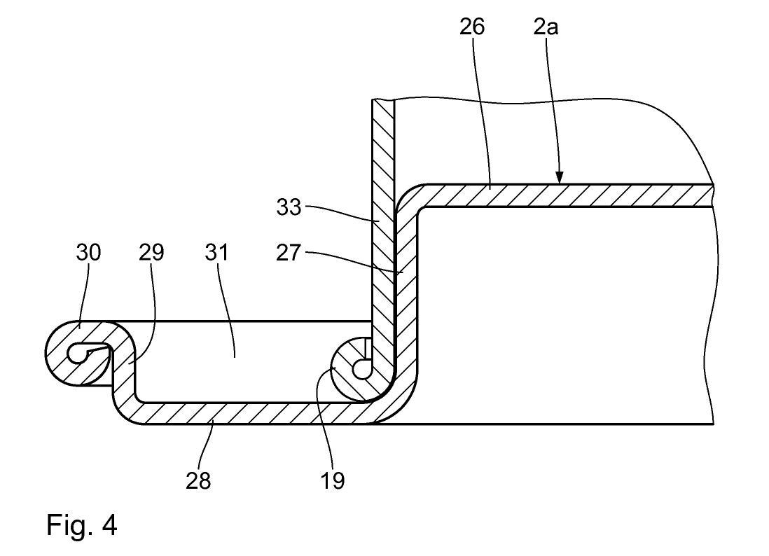

The following is a description, with reference to FIGS. 3 and 4, of a preferred second embodiment of the invention. Identical components are denoted by the same reference numerals as in the first embodiment to which reference is made. Differently designed components having the same function are denoted by identical reference numerals with a subsequent “a”.

Again, the springform pan 1 comprises a bottom 2a and a rim 3a whose contour is substantially in the shape of a triangle or in the shape of a segment of a circle, preferably in the shape of a quarter of a circle.

The bottom 2a has a bottom plate 26 whose basic shape corresponds to the contour of the rim 3a. It is in the shape of a quarter of a circle. Furthermore, the bottom 2a has a circumferential side wall 27 which adjoins the outside of the bottom plate 26 and extends downwards from the bottom plate 26. Between the side wall 27 and the bottom plate 26, there is an angle which amounts to 90° or approximately 90°. The side wall 27 is adjoined by an outwardly projecting trough bottom 28 which forms an angle of 90° or approximately 90° with the side wall 27 and is closed when seen in the circumferential direction. The trough bottom 28 is parallel to the bottom plate 26. The outside of the trough bottom 28 is provided with an upwardly projecting, circumferential boundary web 29 which is perpendicular or substantially perpendicular to the trough bottom 28. The side wall 27 and the boundary web 29 are substantially parallel to each other. They are opposite to each other. Seen from the trough bottom 28, the boundary web 29 has a lower height than the side wall 27. The upper side of the boundary web 29 is provided with a flared edge 30. The bottom plate 26, the side wall 27, the trough bottom 28, the boundary web 29 and the flared edge 30 together form the bottom 2a. The trough bottom 28 allows the bottom 2a to be supported on a basis.

Furthermore, the bottom 2a has a circumferential receiving trough 31 which is downwardly bounded by the trough bottom 28. The receiving trough 31 is inwardly bounded by the side wall 27. The receiving trough 31 is outwardly bounded by the boundary web 29. The receiving trough 31 is tray-like and upwardly open. It has a U-shaped cross-section. The receiving trough 31 may however also have another cross-sectional shape.

The rim 3a of the embodiment shown in FIGS. 3 and 4 differs from the rim 3 of the embodiment according to FIGS. 1 and 2 in that the rim 3a does not have a bead 20 and is therefore not provided with a groove 21 either. The rim 3a extends from the upper bulge 14 in the direction of the flared edge 19 in a substantially straight direction. Furthermore, the flared edge 19 of the second embodiment is flared, in other words rolled, outwards. In contrast to the first embodiment, the bulge 14 and the flared edge 19 of the second embodiment are not provided with bending wires 22.

Furthermore, the rim 3a is formed in one piece. The first rim portion 7 forms a central angle with the second rim portion 9 which preferably amounts to 90°. Between the first rim portion 7 and the second rim portion 9, there is a bending region or curved region 23a which is provided in the center M of the contour, which is in the shape of a segment of a circle, and allows for a relative pivoting movement to occur between the first rim portion 7 and the second rim portion 9 when the closure 13a is operated. The bending region 23a thus forms a kind of hinge 8a in the manner of an integral hinge having a hinge axis 35. It is formed in one piece with the first rim portion 7 and the second rim portion 9; in other words it forms an integral region of the rim 3a. The bending region 23a is thus formed directly in the rim 3a. It is therefore made of the same material as the first rim portion 7 and the second rim portion 9. The bending region 23a forms a connection angle such that the rim 3a is provided with a corner. The bending region 23a is formed by bending the first rim portion 7 and the second rim portion 9 towards each other. The bending region 23a preferably has resilient properties and defines the hinge axis 25 of the first rim portion 7 or the second rim portion 9, respectively. It extends between the bulge 14 and the flared edge 19 at right angles thereto.

The rim 3a comprising the hinge 8a, in other words the bending region 23a, is producible by bending a strip of sheet metal.

The following is an explanation of the functioning of the inventive springform pan 1a according to the second embodiment. When the closure 13a is in its closed position and the rim 3a is connected to the bottom 2a in accordance with its intended purpose, a lower foot region 33 of the rim 3a abuts the outside of the side wall 27. The foot region 33 is then pressed tightly against the side wall 27 from outside so as to enclose the side wall 27. The bottom 2a and the rim 3a are rigidly clamped to each other so as to form a tight connection. The central angle of the rim 3a amounts to 90°. The flared edge 19 is furthermore supported on the trough bottom 28. It is arranged at a distance to the boundary web 29. Therefore, one function of the receiving trough 31 is to receive the flared edge 19, i.e. the side wall 27.

When the closure 13a is opened, the central angle of the rim 3a is increased by a pivoting movement of the rim portions 7, 9 relative to each other when pivoted about the hinge axis 25. When this happens, it is advantageous for the integral bending region 23a to have resilient properties which facilitate the opening of the closure 13a and the expansion of the rim 3a. The bottom 2a and the rim 3a are then easily separable from each other. The closure 13a is closed against a spring bias of the integral bending region 23a.

Another function of the receiving trough 31 is to receive dough which has run over the rim 3a. The receiving trough 31 therefore also forms an overflow protection.

Due to its one-piece design, the rim 3a is producible in an extremely simple and cost-effective manner and does not require a laborious assembly. Another advantage of the integral design of the rim 3a including the bending region 32a is that density problems are avoided.

What is claimed is:

1. A springform pan for baking pastries such as cake, with the springform pan (1; 1a) comprising
a. a bottom (2; 2a);
b. a rim (3; 3a) which is connectable to the bottom (2; 2a), the rim (3; 3a) comprising
i. a first rim portion (7);
ii. a second rim portion (9); and
iii. a third rim portion (10); and
c. a closure (13; 13a) which is provided at the third rim portion (10) for opening and closing the springform pan (1; 1a), with the first rim portion (7) and the second rim portion (9) being pivotably connected to each other.

2. A springform pan according to claim 1, wherein the rim (3; 3a) has a contour in the shape of a segment of a circle having a center (M) when the springform pan (1; 1a) is in a closed position.

3. A springform pan according to claim 2, wherein the rim (3; 3a) has a contour in the shape of a segment of a circle having a central angle of 90° when the springform pan (1; 1a) is in a closed position.

4. A springform pan according to claim 1, wherein the bottom (2; 2a) is in the shape of a segment of a circle having a center (M) when the springform pan (1; 1a) is in a closed position.

5. A springform pan according to claim 4, wherein the bottom (2; 2a) is in the shape of a segment of a circle having a central angle of 90° when the springform pan (1; 1a) is in a closed position.

6. A springform pan according to claim 1, comprising a hinge (8; 8a) for pivotably connecting the first rim portion (7) to the second rim portion (9).

7. A springform pan according to claim 4, wherein the bottom (2; 2a) is connected with the rim (3; 3a) in such a way that the hinge (8; 8a) is arranged at the center (M).

8. A springform pan according to claim 1, wherein the first rim portion (7) and the second rim portion (9) are plane.

9. A springform pan according to claim 1, wherein the third rim portion (10) is convex.

10. A springform pan according to claim 1, wherein the third rim portion (10) has a two-part design comprising an outer part (11) and an inner part (12).

11. A springform pan according to claim 10, wherein the outer part (11) is displaceable relative to the inner part (12).

12. A springform pan according to claim 10, wherein the outer part (11) is formed in one piece with the first rim portion (7) while the inner part (12) is formed in one piece with the second rim portion (9).

13. A springform pan according to claim 1, comprising a circumferential bead (20) of the rim (3), the bead (20) projecting into an inner space (4).

14. A springform pan according to claim 13, wherein the inner space (4) is enclosed by the springform pan.

15. A springform pan according to claim 1, wherein the bottom (2; 2a) is fixable to the rim (3; 3a) by clamping.

16. A springform pan according to claim 1, wherein the bottom (2a) comprises a side wall (27) to which the rim (3a) is connectable.

17. A springform pan according to claim 16, wherein the bottom (2a) furthermore has a receiving trough (31) which is inwardly bounded by the side wall (27).

18. A springform pan according to claim 1, wherein the first rim portion (7) and the second rim portion (9) are formed integrally with each other and are connected via an integral bending region (23a), with the first rim portion (7) and the second rim portion (9) being pivotable relative to each other via the integral bending region (23a).

19. A springform pan according to claim 18, wherein the integral bending region (23a) is spring-like.

20. A springform pan according to claim 19, wherein the bending region (23a) is formed in such a way that the closure (13a) is closed against a spring bias of the integral bending region (23a).
